(19) United States
(12) Patent Application Publication
(10) Pub. No.: US 2015/0134349 A1
(43) Pub. Date: May 14, 2015

(54) SYSTEM AND METHOD FOR QUALITY REVIEW OF HEALTHCARE REPORTING AND FEEDBACK

(71) Applicant: KONINKLIJKE PHILIPS N.V., EINDHOVEN (NL)

(72) Inventors: RICHARD VDOVJAK, EINDHOVEN (NL); ANCA IOANA DANIELA BUCUR, EINDHOVEN (NL)

(21) Appl. No.: 14/521,529

(22) Filed: Oct. 23, 2014

Related U.S. Application Data
(60) Provisional application No. 61/903,456, filed on Nov. 13, 2013.

(51) Int. Cl. G06Q 10/06; G06Q 50/22

(52) U.S. Cl. CPC G06Q 10/06395; G06Q 50/22
USPC 705/2

(57) ABSTRACT

A system and method for providing quality review of healthcare reporting and supporting quality improvement. The system and method performing the steps of multiplying a select number of cases of a plurality of cases to be analyzed using a processor, assigning the plurality of cases and multiplied cases to members of a work pool using the processor, retrieving case reports created by members of the work pool for the multiplied cases and analyzing case reports for one of the multiplied cases in a first review using the processor.

### BACKGROUND

Resource-constrained healthcare environments, such as those in emerging markets, demand very high throughput. The demand for high throughput puts a strain on the effective and efficient utilization of resources as well as the desired quality of the outcome. The volume of patients that are served by clinical departments is vast and the time a clinical expert spends reviewing a patient case is often just a few minutes. In booming healthcare markets like China, the lack of skilled senior clinical personnel is very apparent. Many young doctors and medical students join clinical practices to aid the overloaded healthcare system. Their inexperience, however, introduces a severe knowledge gap between a senior experienced physician and a junior physician.

One of the main challenges in these emerging markets is to keep-up with the increasing demand for healthcare services while assuring adequate quality. In service-focused departments such as radiology and pathology, there are often a large number of junior physicians performing the image reading or tissue analysis on which reports are based. A senior physician may be too busy to review all of the reports and/or conclusions generated by the junior physicians. The primary key performance indicator (KPI) of the department is usually the throughput (e.g., the number of cases reviewed per time unit). However, a KPI reflecting quality is seldom quantified, as it is difficult to detect errors. In addition, when errors do occur, there is very little personal feedback, making it difficult for the junior physicians to improve in their field.

### SUMMARY OF THE INVENTION

A method for providing quality review of healthcare reporting and supporting quality improvement. The method including multiplying a select number of cases of a plurality of cases to be analyzed using a processor, assigning the plurality of cases and multiplied cases to members of a work pool using the processor, retrieving case reports created by members of the work pool for the multiplied cases and analyzing case reports for one of the multiplied cases in a first review using the processor.

A system for providing quality review of healthcare reporting. The system having a processor multiplying a select number of cases of a plurality of cases to be analyzed, assigning the plurality of cases and multiplied cases to members of a work pool, retrieving case reports created by members of the work pool for the multiplied cases, and analyzing case reports for one of the multiplied cases in a first review and a memory storing retrieved case reports created by the members for the multiplied cases in a results database.

### BRIEF DESCRIPTION OF THE DRAWINGS

FIG. 1 shows a schematic drawing of a system according to an exemplary embodiment.

FIG. 2 shows another schematic drawing of the system of FIG. 1.

FIG. 3 shows a flow diagram of a method according to an exemplary embodiment.

### DETAILED DESCRIPTION

The exemplary embodiments may be further understood with reference to the following description and the appended drawings, wherein like elements are referred to with the same reference numerals. The exemplary embodiments relate to a system and method for quality evaluation and improving personalized feedback for healthcare professionals. In particular, the exemplary embodiments provide a system and method for reviewing case reports created by members within a clinical work pool to identify errors and analyze the performance of individual members within the clinical work pool to provide personalized feedback to the members. The system and method may be utilized in emerging markets as well as teaching hospitals in more mature markets. The system and method may be applied directly to the context of radiology (PACS/RIS), digital pathology, but may also be applied in the context of Cardiovascular Information Systems (CVIS) and all related clinical pathway solutions.

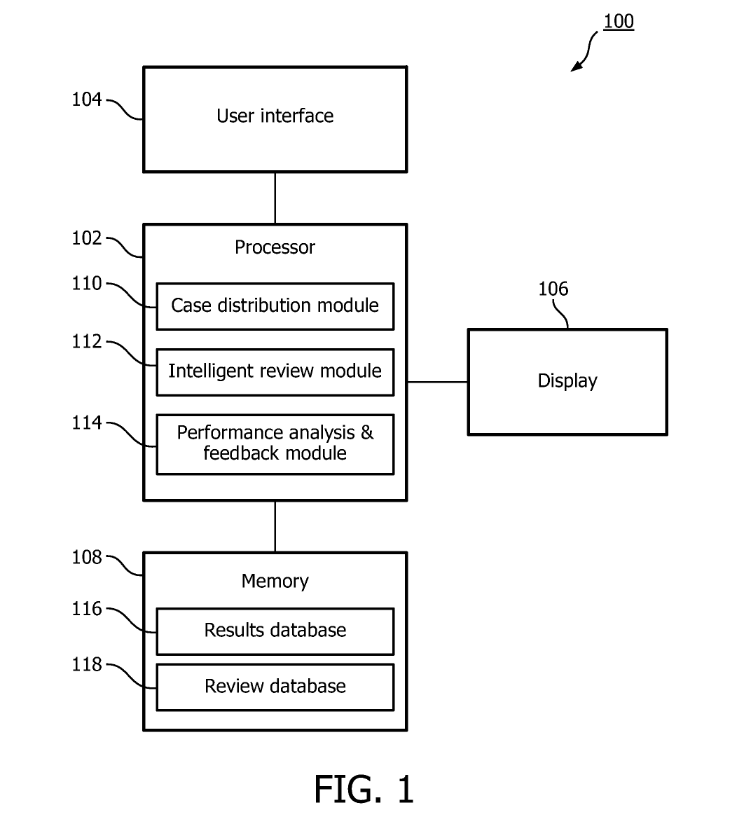

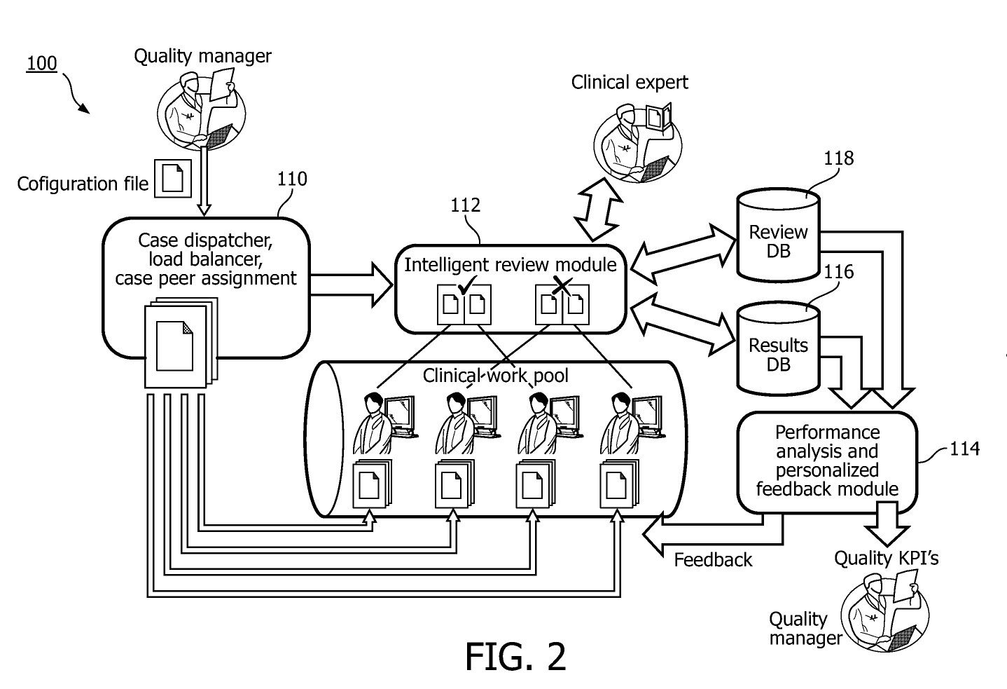

As shown in FIGS. 1-2, a system 100 according to an exemplary embodiment of the present disclosure evaluates the quality of reporting within a clinical work pool and supports quality improvement by efficient review and feedback. The system 100 comprises a processor 102, a user interface 104, a display 106 and a memory 108. The processor 102 distributes incoming cases among the members within the clinical work pool via a distribution module 110. In a radiology setting, for example, the cases may include images which require analysis. The distribution module 110 may further include a case dispatcher and load balancer, which distributes cases while ensuring a balanced workload between each of the members. The distribution module 110 may also include a case peer assignment module which duplicates some of the cases such that the same case may be assigned to more than one member within the clinical work pool. A duplication rate may be set by a user (e.g., a quality manager) via the user interface 104. The user interface may include input devices such as, for example, a keyboard, a mouse and/or touch display on the display 106.

Each of the members creates reports for each case which they are assigned. The reports are based on their readings of the cases (e.g., analysis of a mass in an image) and are saved to a results database 116 within the memory 108. The processor 102 further includes an intelligent review module 112, which collects the reports of the duplicated cases, and analyzes both the structured data in the report as well as the outcome of the report to identify errors and conflicts in a first review. The structured data may include, for example, lab results and patient data (e.g., temperature and blood pressure). Basic errors in structured data may be automatically detected. Basic errors may include, for example, the usage of incorrect measuring units. The review module 112 analyzes the outcomes by comparing the outcomes contained within the reports of a single duplicated case. When the outcomes within the reports do not match (e.g., there are conflicts among reviews of a case), the reports are transmitted to a senior reviewer who analyzes the reports and produces a second review for each. Results of both the first and second reviews may be stored in a review database 118 within the memory 108. The senior reviewer may also create an annotated report including corrections of any errors found within the report. An annotated report may also be automatically generated when errors in structured data are identified by the intelligent review module 112. Annotated reports may be saved to the results database 116.

The processor 102 may further include a performance analysis and feedback module 114, which computes aggregate statistics regarding the error rate, the conflict rate and other KPIs that may be of interest to the user. The error rate and KPI may be utilized by the user to determine whether the duplication rate in the system for the case peer assignment module should be adjusted. The performance analysis and feedback module 114 also compiles individualized feedback for all members within the clinical work pool. The individualized feedback may include information such as the reports created by the member, the results of the first and/or second reviews, and in situations in which it was determined that there was an error, a copy of the correct report (i.e., an annotated report created by the senior reviewer or the correct report created by the other member within the clinical work pool who was assigned a duplicate of the same case). Any and/or all of the components included in the individualized feedback may be displayed on the display 106 to be viewed by individual members of the clinical work pool.

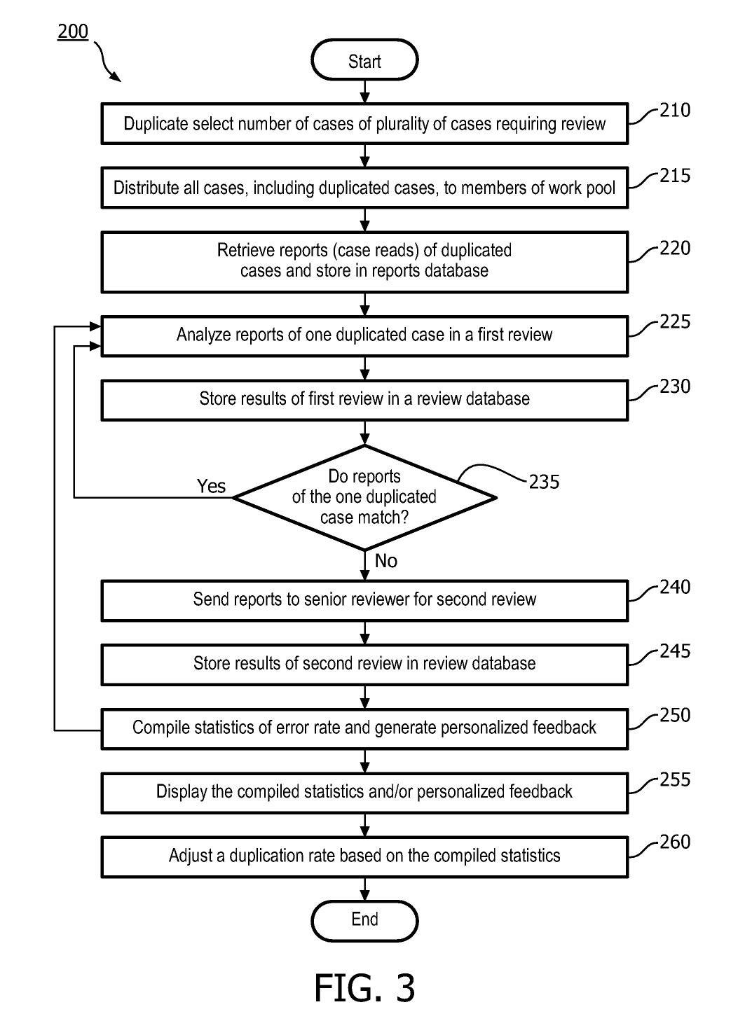

FIG. 3 shows an exemplary method 200 for evaluating the quality of reporting within a clinical work pool using the system 100. Members of the clinical work pool should generally be of the same level of expertise. In a step 210, the system 100 retrieves cases requiring review and duplicates a number of the cases based on the duplication rate set within the case peer assignment of the distribution module. The duplication rate is set as a parameter by the user (e.g., Quality Manager). The user may consider an acceptable level of duplication along with the desired quality monitoring and feedback generation. The user may set a higher rate of duplication for a less experienced clinical work pool to prevent medical errors and provide feedback to support learning. For example, the user may set the case peer assignment of the distribution module 110 to duplicate every 10^{th} case for clinical work pools comprising junior level physicians, but set the duplication rate as 1 out of every 100 cases for more experienced physicians. Thus, the number of cases being distributed (including duplicates) is only as large as necessary to assure the desired quality outcome. Although the exemplary embodiment describes duplicating (i.e., doubling) a single case, it will be understood by those of skill in the art that the case peer assignment may also be set to multiply a single case by any number for distribution, as desired. This parameter may also be set by the user.

In a step 215, the case dispatcher of the distribution module 110 distributes the cases requiring review and the duplicated cases among the members of the clinical work pool. The load balancer of the distribution module 110 ensures that the workload is balanced between each of the members. Members create reports (e.g., case reads) outlining their analysis and including all relevant information for all of the cases which they are assigned. Members who are assigned duplicate cases will not know which of the other members have been assigned a duplicate of one of their cases. Thus, members cannot influence one another. However, all members should be aware that duplicate cases are being assigned such that members are motivated to deliver high quality output.

In a step 220, the system 100 retrieves all of the reports based on duplicated cases. In a step 225, the intelligent review module 112 of the processor 102 analyzes the reports resulting from one of the duplicated cases in a first review. The first review may include analyzing the reports for basic errors, which may include errors in structured data such as, for example, the usage of incorrect measuring units. Where errors are identified, the errors are corrected and saved to an annotated report, which is stored in a results database 116. The first review also includes comparing the reports of the one duplicated case in a first review. When necessary, a Natural Language Processing (NLP) program may be used to convert the contents of the report to text such that textual information contained within the reports may be compared to one another. The intelligent review module 112 determines whether the analysis and information contained within the reports match one another. The results of the first review are stored in the review database 118, in a step 230.

In a step 235, the processor 102 determines whether the first review indicates that results of the one duplicated case match one another. If it is determined that the reports matched one another, the system 100 determines that there is no error and reverts back to the step 225 so that the intelligent review module 112 may begin to analyze the results of another duplicated case. In addition, the correct reports may also be stored to the results database 116 for reference purposes. If it is determined that the reports did not match one another, the method 200 proceeds to a step 240 in which the reports of the one duplicated case is passed on to a senior reviewer for a second review. The senior reviewer analyzes both reports and corrects any errors in an annotated report which may be stored to the results database 116. In a step 245, results of the second review are stored to the review database 118. Once the second review has been completed, the method 200 reverts to the step 225 so that the intelligent review module 112 can begin reviewing the results of another one of the duplicated cases. It will be understood by those of skill in the art that steps 225-245 may be repeated, as necessary, until results of all of the duplicated cases have been reviewed by the intelligent review module 112 and/or a senior reviewer.

Once results of all of the duplicated cases have been reviewed, the method 200 proceeds to a step 250 in which the performance analysis and personalized feedback module 114 computes aggregate statistics regarding the error rate and other quality KPIs. For example, the performance analysis and personalized feedback module 114 may determine the number of duplicate cases including errors and the level of errors (e.g., basic errors or errors in case analysis) contained within those cases including errors. The performance analysis and feedback module 114 also compiles personalized feedback for individual members within the clinical work pool and, particularly, those members who have been assigned duplicate cases. The personalized feedback may include, for example, the reports created by the individual member, first and/or second review results, and, in cases where an error was identified, a copy of the correct report. The correct report may be produced either by another member of the clinical work pool that was assigned the same duplicate case or may be an annotated report created by the senior reviewer who reviewed the member's report. Any and/or all of the components of the personalized feedback may be displayed on the display 106, in a step 255 for review by the individual member. Such personalized feedback is invaluable for providing motivation as well as an environment in which clinicians can learn from one another and their mistakes.

In a step 260, the user may adjust the duplication rate of the distribution module 110 case peer assignment based on the calculated aggregate statistics regarding error rate and KPI in the step 255. The duplication rate may be adjusted by the user via the user interface 104. In another embodiment, however, the duplication rate may be automatically adjusted based on predetermined parameters. For example, where the error rate is below a predetermined threshold, the duplication rate may be decreased, and where the error rate is above a predetermined threshold the duplication rate may be increased. In situations where the error rate is within a predetermined threshold range, the duplication rate may remain unchanged. It will be understood by those of skill in the art that the predetermined threshold may be set by the user.

It is noted that the claims may include reference signs/numerals in accordance with PCT rule 6.2(b). However, the present claims should not be considered to be limited to the exemplary embodiments corresponding to the reference signs/numerals.

Those skilled in the art will understand that the above-described exemplary embodiments may be implemented in any number of manners, including, as a separate software module, as a combination of hardware and software, etc. For example, the case distribution module 110, the intelligent review module 112 and the performance analysis and personalized feedback module 114 may be programs containing lines of code that, when compiled, may be executed by a processor.

It will be apparent to those skilled in the art t hat various modifications may be made to the disclosed exemplary embodiments and methods and alternative without departing from the sprit or scope of the disclosure. Thus, it is intended that the present disclosure cover the modifications and variations provided that the come within the scope of the appended claim and their equivalents.

What is claimed is:

1. A method for providing quality review of healthcare reporting and supporting quality improvement, comprising:
multiplying a select number of cases of a plurality of cases to be analyzed using a processor;
assigning the plurality of cases and multiplied cases to members of a work pool using the processor;
retrieving case reports created by members of the work pool for the multiplied cases; and
analyzing case reports for one of the multiplied cases in a first review using the processor.

2. The method of claim 1, wherein the first review includes reviewing the reports to identify errors in structured data.

3. The method of claim 1, wherein the first review includes comparing the reports of the one of the multiplied cases.

4. The method of claim 3, further comprising sending the reports of the one of the multiplied cases to a senior reviewer for a second review when it is determined that the reports of the one of the multiplied cases do not match.

5. The method of claim 4, further comprising storing results of one of the first review and the second review in a review database of a memory.

6. The method of claim 1, further comprising storing one of the retrieved reports for the multiplied cases and annotated reports correcting reports including errors in a results database.

7. The method of claim 1, further comprising calculating statistics regarding an error rate of the multiplied cases using the processor.

8. The method of claim 4, further comprising compiling personalized feedback for the members of the work pool based on one of the first review and the second review.

9. The method of claim 8, wherein the personalized feedback includes at least one of a report created by a member of the work pool based on the one of the multiplied cases assigned to the member, first review results for the report created by the member, second review results for the report created by the member, and a correct report based on the one of the multiplied cases assigned to the member.

10. The method of claim 1, further comprising setting a multiplication rate, via a user interface, indicating a rate at which the plurality of cases to be analyzed is multiplied.

11. A system for providing quality review of healthcare reporting, comprising:
a processor multiplying a select number of cases of a plurality of cases to be analyzed, assigning the plurality of cases and multiplied cases to members of a work pool, retrieving case reports created by members of the work pool for the multiplied cases, and analyzing case reports for one of the multiplied cases in a first review; and
a memory storing retrieved case reports created by the members for the multiplied cases in a results database.

12. The system of claim 11, wherein the first review includes one of reviewing the reports to identify errors in structured data and comparing the reports of the one of the multiplied cases.

13. The system of claim 12, wherein the processor sends the reports of the one of the multiplied cases to a senior reviewer for a second review when it is determined that the reports of the one of the multiplied cases do not match.

14. The system of claim 13, wherein the memory stores results of one of the first review and the second review in a review database.

15. The system of claim 11, wherein the memory stores annotated reports correcting reports including errors in the results database.

16. The system of claim 11, wherein the processor calculates statistics regarding an error rate of the multiplied cases using the processor.

17. The system of claim 13, wherein the processor compiles personalized feedback for the members of the work pool based on one of the first review and the second review.

18. The system of claim 17, wherein the personalized feedback includes at least one of a report created by a member of the work pool based on the one of the multiplied cases assigned to the member, first review results for the report created by the member, second review results for the report created by the member, and a correct report based on the one of the multiplied cases assigned to the member.

19. The system of claim 11, further comprising a user interface via which a multiplication rate indicating a rate at which the plurality of cases to be analyzed is multiplied is set by a user.

20. A non-transitory computer-readable storage medium including a set of instructions executable by a processor, the set of instructions when executed by the processor causing the processor to perform operations comprising:
multiplying a select number of cases of a plurality of cases to be analyzed using a processor;
assigning the plurality of cases and multiplied cases to members of a work pool using the processor;
retrieving case reports created by members of the work pool for the multiplied cases; and
analyzing case reports for one of the multiplied cases in a first review using the processor.
